(19) United States
(12) Patent Application Publication
(10) Pub. No.: US 2026/0145956 A1
(43) Pub. Date: May 28, 2026

(54) LITHIUM RECOVERY BY LEACHING FROM WASTE CATIONIC MATERIALS AND METHOD FOR PREPARATION OF LITHIUM CARBONATE

(71) Applicant: COSMOCHEMICAL CO., LTD., Seoul (KR)

(72) Inventors: DA KYEONG BAEK, Ulsan (KR); EUIHYUK KWON, Incheon (KR); BYEONG KYU HAN, Busan (KR); BAE SIK KANG, Ulsan (KR)

(21) Appl. No.: 18/962,769

(22) Filed: Nov. 27, 2024

(30) Foreign Application Priority Data
Nov. 27, 2024 (KR) 10-2024-0171758

(51) Int. Cl. C01D 15/08; C01D 7/26; C22B 3/00; C22B 3/44; C22B 7/00; C22B 23/02; C22B 26/12; C22B 47/00; H01M 10/54

(52) U.S. Cl. CPC C01D 15/08; C01D 7/26; C22B 3/44; C22B 7/001; C22B 7/007; C22B 23/02; C22B 23/0415; C22B 26/12; C22B 47/00; H01M 10/54; C01P 2002/72

(57) ABSTRACT

One embodiment provides a method of selectively recovering lithium from a waste cathode active material, the method including: a step of mixing and calcining a waste cathode active material and a carbon source; a step of leaching a valuable metal in the calcined mixture under acidic conditions; and a step of recovering the leached valuable metal, wherein, in the step of mixing and calcining the waste cathode active material and the carbon source, lithium contained in the waste cathode active material is converted into lithium carbonate so that lithium is selectively leached through the step of recovering the leached valuable metal, and in the step of mixing and calcining the waste cathode active material and the carbon source, the average particle size of the carbon source is 220 μm or less.

### CROSS-REFERENCE TO RELATED APPLICATIONS

This application claims the priority of Korean Patent Application No. 10-2024-0171758 filed on Nov. 27, 2024, in the Korean Intellectual Property Office, the disclosure of which is incorporated herein by reference.

### BACKGROUND OF THE INVENTION

### Field of the Invention

The present invention relates to a method of recovering lithium from a waste cathode active material through lithium pre-leaching and a method of preparing lithium carbonate, and more specifically, to a method of selectively leaching lithium from a waste cathode active material powder containing nickel (Ni), cobalt (Co), manganese (Mn), lithium (Li), and the like through lithium pre-leaching.

### Description of the Related Art

Lithium secondary batteries are key components of electric vehicles and energy storage systems (ESS), and their demand is rapidly increasing as the supply of renewable energy without environmental pollution is increasing. As the demand for electric vehicle batteries increases, the production of nickel (Ni)-cobalt (Co)-manganese (Mn) (NCM)-based lithium ion batteries (LIBs) cathode active materials is also increasing.

Accordingly, the ternary cathode active materials of lithium secondary batteries generated from electric vehicles and ESSs that have reached the end of their lifetime contain expensive valuable metals such as lithium (Li), cobalt (Co), and nickel (Ni), and the development of an effective and economically feasible process is required to recover these valuable metals and recycle them as raw materials for lithium secondary batteries. Conventionally, in order to recover valuable metals from conventional waste cathode active materials, LIB scrap is leached in an acidic solution, and manganese, cobalt, nickel, and lithium, which are valuable metals, are recovered through a stepwise recovery process including manganese recovery-cobalt recovery-nickel recovery-lithium recovery.

However, since the removal of lithium is the final step in this process, there has been a problem that the loss rate of lithium is high, and the manufacturing cost increases due to the process of recovering each valuable metal with high purity.

In addition, conventionally, after leaching the waste cathode active material by non-selective dissolution, the valuable metals are recovered through the steps of impurity removal-NCM coprecipitation, Li removal-sulfuric acid re-dissolution, but since the removal of lithium is the final step, the loss rate of lithium is high, and additional processes such as sulfuric acid re-dissolution and impurity removal must be carried out to recover the NCM coprecipitation product, so there has been a problem of low economic feasibility.

Moreover, conventionally, in order to selectively recover only lithium from waste cathode active materials, a dry reduction heat treatment is performed at 600° C. or higher with hydrogen, activated carbon, sodium carbonate, and the like, and a stepwise dry (reduction heat treatment)-wet (water leaching) process is used, but this also has the problem that the process is complicated and that a large amount of energy is consumed to recover lithium.

Therefore, in order to easily perform selective removal or recovery of lithium from a waste cathode active material by a wet process, the present inventors have developed a method for selectively leaching lithium from a cathode active material by mixing a waste cathode active material with activated carbon of a certain size or less and then reducing and calcining the mixture by adding a small amount of sulfuric acid and distilled water, thereby deriving the present invention.

### RELATED ART DOCUMENTS

### Patent Document

(Patent document 0001) 1. Korean patent publication 10-2013-0071838 (published on Jul. 1, 2013)

### SUMMARY OF THE INVENTION

The present invention has been derived to solve the above-described tasks, and one embodiment of the present invention provides a method for selectively recovering lithium from a waste cathode active material.

The technical task to be achieved by the present invention is not limited to the above-mentioned technical tasks, and other technical tasks that are not mentioned will be clearly understood by one of ordinary skill in the art to which the present invention pertains, from the description below.

As a technical means for achieving the above-described technical task, one aspect of the present invention provides: a method of selectively recovering lithium from a waste cathode active material, the method including: a step of mixing and calcining a waste cathode active material and a carbon source; a step of leaching a valuable metal in the calcined mixture under acidic conditions; and a step of recovering the leached valuable metal, wherein, in the step of mixing and calcining the waste cathode active material and the carbon source, lithium contained in the waste cathode active material is converted into lithium carbonate so that lithium is selectively leached through the step of recovering the leached valuable metal, and in the step of mixing and calcining the waste cathode active material and the carbon source, the average particle size of the carbon source is 220 μm or less.

The step of calcining may be performed at a temperature between 600° C. and 800° C.

The step of leaching a valuable metal in the calcined mixture under acidic conditions may be performed at a temperature of 15° C. to 45° C.

The step of leaching a valuable metal in the calcined mixture under acidic conditions may be performed at a high liquid-to-solid ratio of 5 to 10.

The step of leaching a valuable metal in the calcined mixture under acidic conditions may be performed at pH 4 to 7.

The method of selectively recovering lithium from a waste cathode active material may further include a step of adding a neutralizing agent to a lithium leachate to precipitate and remove impurities other than lithium, after the step of leaching a valuable metal in the calcined mixture.

The impurities may include a carbonate ((Co—Ni—Mn)CO₃) or a hydroxide ((Co—Ni—Mn)(OH)₂).

The neutralizing agent may be one or more selected from the group consisting of NaOH, NH₄OH, Na₂CO₃, K₂CO₃, CaO, CaCO₃, MgCO₃, and MgO.

The step of recovering the leached valuable metal may include a lithium recovery step of heating and concentrating a lithium leachate and then carbonating the same to recover as lithium carbonate.

In the lithium recovery step of heating and concentrating a lithium leachate and then carbonating the same to recover as lithium carbonate, the carbonating may be performed by selecting one or more carbonates from the group consisting of Na₂CO₃, K₂CO₃, CaCO₃, and MgCO₃ and adding the same in an amount of 20 to 120 equivalents relative to the calcium concentration of a lithium leachate.

The lithium recovery step of heating and concentrating a lithium leachate and then carbonating the same to recover as lithium carbonate may be performed at a temperature between 60° C. and 95° C.

The lithium recovery step of heating and concentrating a lithium leachate and then carbonating the same to recover as lithium carbonate may be performed for 0.1 to 2 hours.

In the lithium recovery step of heating and concentrating a lithium leachate and then carbonating the same to recover as lithium carbonate, after the carbonate is added, a base is added to adjust the pH to 11 to 12.

The method of selectively recovering lithium from a waste cathode active material may further include a step of performing washing for 0.1 to 2 hours under the conditions of a liquid-to-solid ratio of 7 to 15:1, after the lithium recovery step of heating and concentrating a lithium leachate and then carbonating the same to recover as lithium carbonate.

The method of selectively recovering lithium from a waste cathode active material may further include a step of recovering valuable metals of cobalt (Co), nickel (Ni), and manganese (Mn) from a residue separated from a lithium leachate leached by the step of leaching a valuable metal in the calcined mixture under acidic conditions.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a schematic flowchart of a method for separating and recovering a valuable metal from waste cathode active material powder according to one embodiment of the present invention;

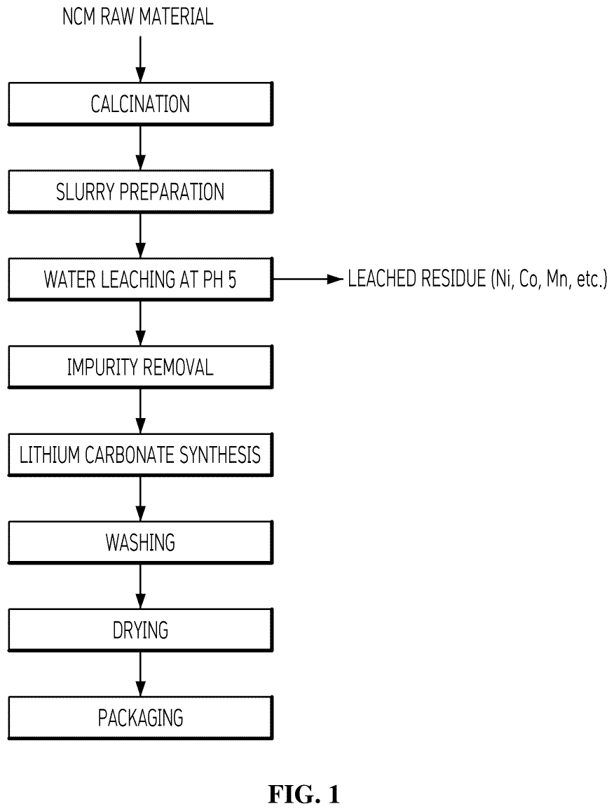

FIG. 2 shows a diagram illustrating the results of an X-ray diffraction (XRD) analysis of a residue obtained through a reduction heat treatment reaction of waste cathode active material powder according to one embodiment of the present invention in the case where the activated carbon particle size is 220 μm or less; and

FIG. 3 shows a diagram illustrating the results of an XRD analysis of a residue obtained through a reduction heat treatment reaction of waste cathode active material powder according to one embodiment of the present invention in the case where the activated carbon particle size is 220 μm or more.

### DETAILED DESCRIPTION OF THE EMBODIMENTS

Hereinafter, the present invention will be described in more detail. However, the present invention may be implemented in various different forms and the present invention is not limited to the embodiments described herein, and the present invention is only defined by the claims set forth below.

In addition, the terms used herein are only used to describe specific embodiments and are not intended to limit the invention. Singular expressions include plural expressions unless the context clearly dictates otherwise. Throughout the specification of the present invention, “comprising” a certain component means that other components may be further included rather than excluding other elements, unless otherwise specified.

Throughout the specification, when a part is described to be “connected (conjugated, contacted, combined)” with another part, this means not only a case of being “directly connected” but also a case of being “indirectly connected” with yet another member therebetween. In addition, when a part is described to “include” a certain component, this does not mean that other components are excluded, but that other components may be further included, unless specifically described otherwise.

The term “slurry composition” used herein may mean a slurry composition for polishing a target film, and the polishing may mean chemical mechanical polishing (CMP).

As used herein, “%” may mean “% by weight” or “wt %” in terms of content, unless otherwise described.

The terms used herein are only used to describe specific embodiments and are not intended to limit the invention. Singular expressions include plural expressions unless the context clearly dictates otherwise.

A first aspect of the present invention provides: a method of selectively recovering lithium from a waste cathode active material, the method including: a step of mixing and calcining a waste cathode active material and a carbon source; a step of leaching a valuable metal in the calcined mixture under acidic conditions; and a step of recovering the leached valuable metal, wherein, in the step of mixing and calcining the waste cathode active material and the carbon source, lithium contained in the waste cathode active material is converted into lithium carbonate so that lithium is selectively leached through the step of recovering the leached valuable metal, and in the step of mixing and calcining the waste cathode active material and the carbon source, the average particle size of the carbon source is 220 μm or less.

Hereinafter, the method for selectively recovering lithium from a waste cathode active material according to the first aspect of the present invention will be described in detail.

First, in one embodiment of the present invention, the method may include a step of mixing and calcining a waste cathode active material and a carbon source. Specifically, in order to selectively recover only lithium in a waste cathode active material, the carbon contained in the carbon source is separated through a reduction and calcination process to increase the lithium recovery rate. Since a waste cathode active material is in an oxide state of Li(Ni_{X}Co_{y}Mn_{z})O₂ (wherein x+y+z=1, 0<x, y, z<1), a highly reactive fine carbon source is added thereto to convert lithium into the form of lithium carbonate as shown below to increase the leaching reactivity. The reaction scheme is show below.

$$12 Li ( {Ni}_{X} {Co}_{y} {Mn}_{z} ) {O}_{2} + 7 C = 6 {Li}_{2} {CO}_{3} + 12 x Ni + 12 yCo + 12 z MnO + {CO}_{2} ( g )$$

In one embodiment of the present invention, a waste cathode active material powder is obtained from a lithium secondary battery cathode active material that is defective during the manufacturing process or discarded, and in particular, Ni—Co—Mn (NCM) ternary waste cathode active material is used. The collected waste cathode active material is prepared in the form of waste cathode active material powder through a calcinating and a predetermined powdering process. In the waste cathode active material powder, various components such as nickel (Ni), cobalt (Co), manganese (Mn), lithium (Li), and trace amounts of aluminum (Al), copper (Cu), iron (Fe), and calcium (Ca) may be mixed. The waste cathode active material powder enables selective dissolution of lithium as the crystal lattice of a layered structure collapses or is deformed by an oxidizing agent.

In one embodiment of the present invention, as the carbon source, any carbon source may be applied without limitation as long as it is capable of converting lithium contained in the waste cathode active material powder into lithium carbonate by calcination, and it may preferably be activated carbon.

In one embodiment of the present invention, the carbon source may be mixed in an amount of 15 to 30 parts by weight, preferably 15 to 25 parts by weight, based on 100 parts by weight of the waste cathode active material powder. When the amount is less than the above-described range, sufficient conversion into lithium carbonate may not be achieved, and when it exceeds the above-described range, the carbon source content may become excessively high, so that it may act as an impurity in a subsequent process.

In one embodiment of the present invention, the method of selectively recovering lithium from a waste cathode active material may include a process of selectively and preemptively recovering only high-purity lithium by performing a wet process of mixing the waste cathode active material powder with a carbon source and calcining the resulting mixture to convert lithium into lithium carbonate, leaching the same under acidic conditions, and then removing impurities and carbonizing a lithium leachate. Thereafter, when a process of leaching and removing impurities from a residue from which lithium has been removed is performed, valuable metals such as cobalt, nickel, and manganese may also be recovered.

In one embodiment of the present invention, in the step of mixing and calcining a waste cathode active material and a carbon source, the average particle size of the carbon source may be 300 μm or less, and preferably 220 μm or less. When the average particle size exceeds the above-described range, reactivity may not be sufficiently secured when charging the carbon source.

In one embodiment of the present invention, the step of calcining may be performed at a temperature between 600° C. and 800° C. Preferably, the calcining may be performed at 650° C. to 750° C., and when the temperature is lower than the above-described range, the carbon source may not react with lithium and the lithium may not be sufficiently converted into lithium carbonate, and when the temperature exceeds the above-described range, the reaction process may be inefficient in terms of energy.

Next, in one embodiment of the present invention, the method may further include a step of leaching a valuable metal in the mixture calcined under acidic conditions.

In one embodiment of the present invention, the step of leaching a valuable metal in the mixture calcined under acidic conditions may be performed at a temperature of 15 to 40° C. The reaction temperature is preferably in the temperature range of 15 to 40° C., and the lower the reaction temperature, the more the solubility of lithium carbonate increases, which is preferable. However, a temperature lower than 15° C. is not preferable because energy is consumed to cool the temperature, and a temperature higher than 45° C. is not preferable because the solubility of lithium carbonate decreases and the cost of energy consumed for the water evaporation reaction and heating increases. More specifically, it is preferable that the step is performed at a room temperature of 15 to 25° C. as the optimal temperature.

In one embodiment of the present invention, the step of leaching a valuable metal in the mixture calcined under acidic conditions may be performed at a pH of 4 to 7. When the pH of the water leaching is 7 or higher, the leaching rate of lithium is low, and when the pH is 4 or lower, the leaching rate of nickel and cobalt increases, and the amount of an alkaline agent required for neutralization increases, which is economically feasible. Here, the pH may be adjusted by selecting and adding at least one from the group consisting of H₂SO₄, HCl, and HNO₃. A more preferable pH range may be a range of 4 to 7.

In one embodiment of the present invention, the reaction time of the step of leaching a valuable metal in the mixture calcined under acidic conditions is preferably in the range of one to four hours, and when it increases to four hours or more, the leaching rate does not improve significantly compared to the increase in the operation time, which may not be preferable.

In one embodiment of the present invention, the step of leaching a valuable metal in the mixture calcined under acidic conditions is preferably performed at a liquid-to-solid ratio (L/S) in the range of 5 to 10, and when the L/S is 10 or higher, the concentration of lithium in the leachate decreases, thereby increasing the cost of energy required to concentrate lithium, and when the L/S is 5 or lower, the concentration of lithium increases more than necessary, thereby causing a problem in that the precipitation reaction of lithium is predominant over the leaching reaction, thereby significantly slowing down the dissolution rate.

In one embodiment of the present invention, the method may further include a step of adding a neutralizing agent to a lithium leachate to precipitate and remove impurities other than lithium, after the step of leaching a valuable metal in the calcined mixture.

In one embodiment of the present invention, an alkaline neutralizing agent may be added to remove impurities (Cu, Al, Ca, etc.) other than lithium from the lithium leachate, and the neutralizing agent may be one or more selected from the group consisting of NaOH, NH₄OH, Na₂CO₃, K₂CO₃, CaO, CaCO₃, MgCO₃, and MgO. However, the pH may be preferably adjusted to a range of 9 to 10 using sodium carbonate (Na₂CO₃).

In one embodiment of the present invention, after the neutralization using a neutralizing agent as described above, the obtained precipitate may contain impurities such as cobalt, nickel, and manganese in addition to Cu, Al, and Ca. At this time, the properties of the nickel, cobalt, and manganese precipitates vary depending on the type of the alkaline agent, and may be mainly obtained as a carbonate ((Co—Ni—Mn)CO₃) or hydroxide ((Co—Ni—Mn)(OH)₂) coprecipitation product.

In one embodiment of the present invention, the neutralizing agent may be one or more selected from the group consisting of NaOH, NH₄OH, Na₂CO₃, K₂CO₃, CaO, CaCO₃, MgCO₃, and MgO.

Next, in one embodiment of the present invention, the method may include a step of recovering the leached valuable metal.

In one embodiment of the present invention, the step of recovering the leached valuable metal may include a lithium recovery step of heating and concentrating a lithium leachate and then carbonating the same to recover as lithium carbonate.

In one embodiment of the present invention, in the lithium recovery step of heating and concentrating a lithium leachate and then carbonating the same to recover as lithium carbonate, the carbonating may be performed by selecting one or more carbonates from the group consisting of Na₂CO₃, K₂CO₃, CaCO₃, and MgCO₃ and adding the same in an amount of 20 to 120 equivalents relative to the calcium concentration of a lithium leachate. In other words, lithium carbonate may be recovered by adding the carbonate at a concentration corresponding to 20 to 120 moles relative to 1 mol of calcium contained in the lithium leachate. Preferably, the carbonating may be performed by selecting one or more carbonates from the group consisting of Na₂CO₃, K₂CO₃, CaCO₃, and MgCO₃ adding the same in an amount of 30 to 120 equivalents relative to the calcium concentration of the lithium leachate, more preferably 50 to 120 equivalents.

In one embodiment of the present invention, the lithium recovery step of heating and concentrating a lithium leachate and then carbonating the same to recover as lithium carbonate may be performed at a temperature between 60° C. and 95° C. In other words, the heating and concentrating may be performed at a temperature of 60 to 95° C., and preferably, the heating and concentrating may be performed at a temperature of 70 to 90° C.

In one embodiment of the present invention, the lithium recovery step of heating and concentrating a lithium leachate and then carbonating the same to recover as lithium carbonate may be performed for 0.1 to 2 hours. When the time is less than the above-described time, the conversion into lithium carbonate may not be sufficiently achieved, and when it is more than the above-described range, the reaction time may be unnecessarily long.

In one embodiment of the present invention, in the lithium recovery step of heating and concentrating a lithium leachate and then carbonating the same to recover as lithium carbonate, after the carbonate is added, a base is added to adjust the pH to 11 to 12. At this time, calcium may remain in the lithium leachate when the lithium leachate is neutralized to pH 11 to 12, and there was a problem that calcium was not removed during the washing process when calcium was mixed with lithium carbonate, and in the conventional technology, a substance such as NaF was used, and such a substance had a problem that an F− ion was mixed in. In order to prevent this, a carbonate (e.g., sodium carbonate) is used to remove calcium using the following reaction scheme.

$${Ca}^{2 +} + {Na}_{2} {CO}_{3} = {CaCO}_{3} ( s ) + 2 {Na}^{+}$$

As described above, when calcium is removed using NaF, there is a disadvantage that the concentration of F− ions in the solution increases, which is harmful to the environment, and that the F− ions must be removed through an additional method. On the contrary, as described above, when a carbonate is used, there is an advantage that the process can be simplified.

In one embodiment of the present invention, the method may further include a step of performing washing for 0.1 to 2 hours under the conditions of a liquid-to-solid ratio (ratio of water to lithium carbonate; L/S) of 7 to 15:1, after the lithium recovery step of heating and concentrating a lithium leachate and then carbonating the same to recover as lithium carbonate. By satisfying the above-described range, the removal of calcium and sodium coprecipitated in lithium carbonate can be effectively achieved.

In one embodiment of the present invention, the step of leaching a valuable metal in the calcined mixture under acidic condition may be performed for one to four hours.

In one embodiment of the present invention, the step of leaching valuable metal in the calcined mixture under acidic condition may be performed at a pH of 4 to 7.

In one embodiment of the present invention, the method may further include a step of recovering valuable metals of cobalt (Co), nickel (Ni), and manganese (Mn) from a residue separated from a lithium leachate leached by the step of leaching a valuable metal in the calcined mixture under acidic conditions. In the step of recovering valuable metals of cobalt (Co), nickel (Ni), and manganese (Mn), any method capable of recovering valuable metals of cobalt (Co), nickel (Ni), and manganese (Mn), such as a leaching reaction or an impurity removal reaction, may be used without limitation.

Hereinafter, examples of the present invention will be described in detail so that those skilled in the art can easily implement the present invention. However, the present invention may be implemented in various different forms and is not limited to the examples described herein.

### EXAMPLES

The raw material used in the process was a ternary cathode active material with a NCM composition used in electric vehicle batteries, and the material was purchased in bulk and homogenized before use. The chemical composition of the raw material, which was collected and completely decomposed and analyzed by inductively coupled plasma-atomic emission spectroscopy (ICP-OES), showed an NCM composition of 6.6% cobalt (Co), 46.8% nickel (Ni), 2.7% manganese (Mn), and 6.8% lithium (Li), with 2% aluminum (Al) as the main impurity and trace amounts of iron (Fe), calcium (Ca), and the like in an amount of 0.1% or less. The specific raw material composition is as shown in Table 1 below, which shows an example of the raw material composition of waste NCM cathode active material.

TABLE 1

| Content | Co | Ni | Mn | Fe | Al | Ca | Li |
|---|---|---|---|---|---|---|---|
| wt % | 6.6 | 46.8 | 2.7 | 0.08 | 1.8 | 0.08 | 6.8 |

### Example 1: Lithium Leaching Rate and XRD Analysis According to Carbon Source Particle Size

A mixed waste cathode active material and activated carbon were placed in a calcination furnace at a mixing ratio of 4:1, heated for one hour, and calcinated at 650° C. for 60 minutes.

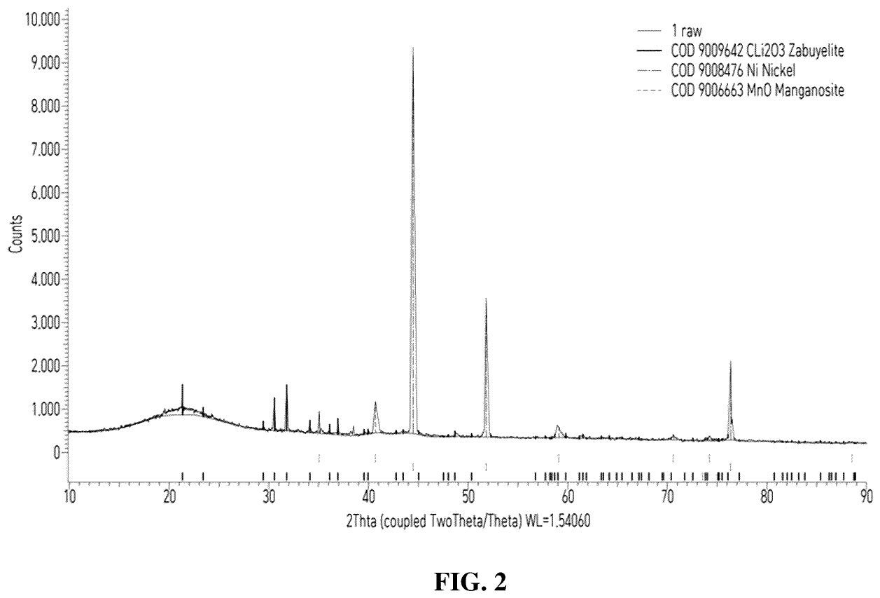

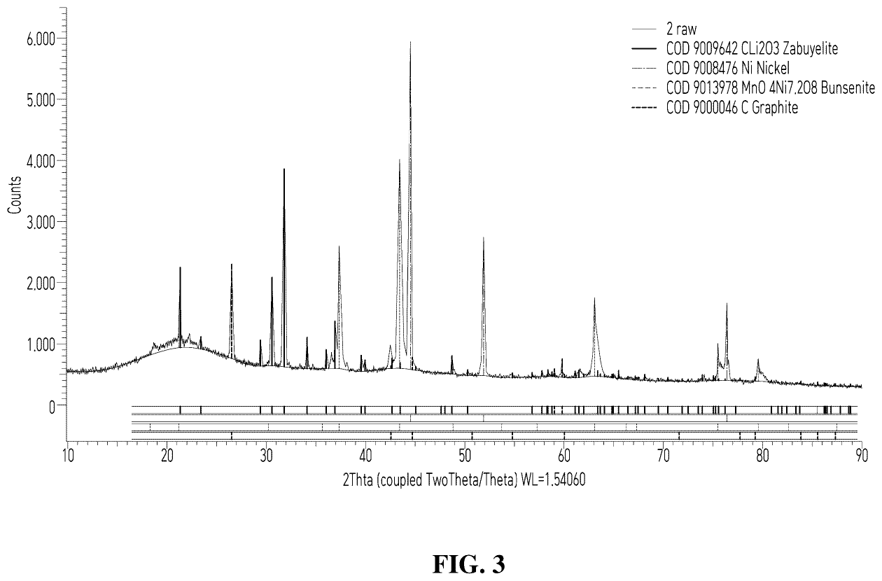

Thereafter, each sample according to the average particle size of the activated carbon was weighed and placed in a beaker at room temperature and a liquid-solid ratio of 5 and stirred at 250 rpm for two hours, and a small amount of 95% sulfuric acid was added thereto to maintain the pH at 5. After the reaction was completed, the solution was filtered through a vacuum filtration device to obtain a leachate and a leachate residue. The leachate residue was dried and subjected to a pre-analysis, and then the metal concentration in the leachate and the leachate residue was analyzed using ICP-OES to calculate the leaching rate. Table 2 below shows the results of the lithium leaching rate according to the particle size of the activated carbon. In addition, FIG. 2 shows a diagram illustrating the results of an XRD analysis of a residue obtained through a reduction heat treatment reaction of waste cathode active material powder according to one embodiment of the present invention, in the case where the activated carbon particle size was 220 μm or less, and FIG. 3 shows a diagram illustrating the results of an XRD analysis of a residue obtained through a reduction heat treatment reaction of waste cathode active material powder according to one embodiment of the present invention in the case where the activated carbon particle size was 220 μm or more.

TABLE 2

| Activated carbon particle size (μm) | Li leaching rate (%) |
|---|---|
| 220~380 | 31.8 |
| 170~220 | 77.0 |
| 140~170 | 80.8 |
| 70~140 | 83.7 |

First, referring to Table 2, when the particle size of the activated carbon was 220 μm or larger, the reactivity was low and thus the lithium leaching rate was low, and when it was 220 μm or smaller, the reactivity was improved and thus the leaching rate increased.

Referring to FIGS. 2 and 3, it can be confirmed that in FIG. 2, lithium was converted into lithium carbonate, and in FIG. 3, it can be confirmed that the raw material exhibited a low leaching rate because the reduction was not good.

### Example 2: Analysis of Suitable Equivalent of Sodium Carbonate in the Step o Leaching Lithium and Removing Impurities

After the calcination, samples in the range of 70 to 140 μm were obtained and leached.

Under acidic conditions, the layered crystal lattice of the NCM cathode active material may partially collapse or be deformed, creating an environment in which lithium may be selectively dissolved. Under the same conditions as Example 1, when leaching was performed at a pH of 7 or higher, the leaching rate was low, and when the pH was 4 or lower, the leaching rate of metals other than lithium increased, so the pH was set to 5. At this time, the dissolution of cobalt, nickel, and manganese was minimized, and only lithium could be selectively leached. After leaching, the residue and the leachate were separated through vacuum filtration.

In order to increase the removal rate of impurities other than lithium, especially Ca, in the preceding lithium pre-leachate, 20 to 100 equivalents of Na₂CO₃ were added relative to the initial Ca concentration, and the solution was stirred for two hours. The initial Ca concentration in the mother liquor was 395 mg/L, and the Ca removal rate increased as the equivalent of sodium carbonate added increased, the Ca concentration decreased to 6.1 mg/L after 100 equivalents were added. Therefore, it is considered preferable to 100 equivalents or more of sodium carbonate relative to the initial Ca concentration. NaOH was added to the neutralized solution containing 100 equivalents of sodium carbonate to adjust the pH to 11, and the detailed results are shown in Table 3.

TABLE 3

| Equivalents | | | | | | | | | | | | |
|---|---|---|---|---|---|---|---|---|---|---|---|---|
| of sodium | | | | | | | | | | | | |
| carbonate | | mg/L | | | | | | | | | | |
| added | | Al | Ca | Co | Cu | Fe | K | Li | Mg | Mn | Na | Ni |
| 0 | eq. | 45 | 395.0 | 6728.6 | 175.0 | 0.0 | 105.2 | 8628.4 | 166.0 | 2466.0 | 3451.5 | 3786.6 |
| 20 | eq. | 1.1 | 124.1 | 0.5 | 0.1 | 0.0 | 198.1 | 8638.6 | 9.0 | 1.7 | 16631.5 | 0.9 |
| 60 | eq. | 0.6 | 24.2 | 1.1 | 0.1 | 0.0 | 216.8 | 9009.4 | 9.7 | 1.1 | 22461.6 | 0.9 |
| 100 | eq. | 0.4 | 6.1 | 3.3 | 0.1 | 0.0 | 218.6 | 7870.1 | 6.3 | 0.7 | 26698.0 | 1.5 |

### Example 3: Analysis of Suitable Equivalent of Sodium Carbonate According to Raw Materials

In order to confirm the difference according to raw materials, NCM samples with the composition shown in Table 4 were obtained, and after calcination under the same conditions as Example 1, samples in the range of 70 to 140 μm were obtained, and leaching was performed under the same conditions as Example 2.

TABLE 4

| Content | Co | Ni | Mn | Fe | Al | Ca | Li |
|---|---|---|---|---|---|---|---|
| wt % | 3.6 | 55.0 | 0.1 | 0.01 | 1.4 | 1.9 | 7.0 |

As shown in Table 5 below, the initial Ca concentration in the mother liquor was 125 mg/L, and it was confirmed that the Ca concentration decreased to 10.8 mg/L after 30 equivalents were added, and the Ca removal rate was confirmed to be 90% or more (91.4%). Therefore, it is considered preferable to add 30 equivalents or more of sodium carbonate relative to the initial Ca concentration in the raw material.

TABLE 5

| Equivalents | | | | | | | | | | | | |
|---|---|---|---|---|---|---|---|---|---|---|---|---|
| of sodium | | | | | | | | | | | | |
| carbonate | | mg/L | | | | | | | | | | |
| added | | Al | Ca | Co | Cu | Fe | K | Li | Mg | Mn | Na | Ni |
| 0 | eq. | 0.6 | 125.0 | 2146.8 | 0.6 | 0.0 | 136.4 | 9008.3 | 67.6 | 386.0 | 24888.7 | 1007.3 |
| 30 | eq. | 0.5 | 10.8 | 0.4 | 0.0 | 0.0 | 147.7 | 8992.7 | 1.9 | 0.0 | 27803.9 | 0.1 |

### Example 4: Lithium Carbonate Synthesis (Recovery)

After removing impurities by neutralization as in Example 2, the sample was heated and concentrated at 80° C., and 1.1 equivalents of sodium carbonate were added based on the lithium concentration to recover lithium carbonate. During the synthesis reaction, the lithium concentration in the mother liquor should be 10 g/L or higher and the pH should be 10 or higher. The reaction time was 0.5 hours, and a mother liquor was prepared to perform the synthesis. The analytical results for the mother liquor and the synthesis leachate are shown in

TABLE 6

| | | mg/L | | | | | | | | | |
|---|---|---|---|---|---|---|---|---|---|---|---|
| Classification | | Al | Ca | Co | Cu | Fe | K | Li | Mg | Mn | [symbol] |
| Synthesis | Mother liquor | 0.3 | 2.5 | 0.9 | 0.0 | 0.0 | 163.5 | 7710.6 | 0.1 | 0.0 | 3 [symbol] |
| | (mg/L) | | | | | | | | | | |
| | Synthesis leachate | 1.1 | 10.9 | 0.2 | 0.2 | 0.0 | 163.4 | 2287.9 | 1.1 | 1.5 | 6 [symbol] |
| | (mg/L) | | | | | | | | | | |
| | Lithium carbonate | 5.0 | 123.0 | 29.0 | 0.6 | 0.0 | 358.0 | 188308.9 | 30.7 | 4.7 | 2 [symbol] |
| | after synthesis | | | | | | | | | | |
| | (mg/kg) | | | | | | | | | | |

[symbol]

indicates data missing or illegible when filed

### Example 5: Removal of Sodium and Calcium after Washing

In order to remove the sodium coprecipitated in the recovered lithium carbonate as well as calcium, the reaction was carried out at a reaction temperature of 80° C. under the conditions of a liquid-to-solid ratio of 10:1, and lithium carbonate with a purity of 99.5% or more (99.78%) was prepared as shown in Table 7 below.

TABLE 7

| | | mg/L | | | | | | | | | |
|---|---|---|---|---|---|---|---|---|---|---|---|
| Classification | | Al | Ca | Co | Cu | Fe | K | Li | Mg | Mn | Na |
| Washing | Leachate after washing | 0.5 | 2.7 | 0.1 | 0.0 | 0.0 | 2.8 | 2202.7 | 0.2 | 0.1 | 1643 [symbol] |
| | (mg/L) | | | | | | | | | | |
| | Lithium carbonate | 5.1 | 90.5 | 33.3 | 0.4 | 0.0 | 53.1 | 185383.8 | 32.5 | 4.7 | 2004 [symbol] |
| | after washing | | | | | | | | | | |
| | (mg/kg) | | | | | | | | | | |

[symbol]

indicates data missing or illegible when filed

In the present invention, lithium can be selectively leached and recovered at a high concentration from a ternary waste cathode active material using a wet process, and lithium carbonate can be synthesized with high purity in a simpler and more economical way than the existing process.

According to an embodiment of the present invention, the method for selectively recovering lithium from a ternary (nickel (Ni)-cobalt (Co)-manganese (Mn); NCM) waste cathode active material according to the present invention can obtain high-purity lithium with a low lithium loss rate by preemptively performing a step of selectively recovering high-purity lithium through a leaching process of the waste cathode active material.

In addition, according to an embodiment of the present invention, a high-purity lithium carbonate can be recovered from a waste cathode active material and reused as a precursor of a cathode active material.

The effects of the present invention are not limited to the above-described effects, and should be understood to include all effects that can be inferred from the features of the invention described in the detailed description or claims of the present invention.

The above description of the present invention is for the purpose of illustration, and one of ordinary skill in the art to which the present invention relates will understand that the present invention can be easily modified into other specific forms without changing the technical spirit or essential features of the present invention. Therefore, the above-described examples should be understood as illustrative rather than limiting in all aspects. For example, each component which has been described as a unitary part can be implemented as distributed parts. Likewise, each component which has been described as distributed parts can also be implemented as a combined part.

The scope of the present invention is presented by the accompanying claims, and it should be understood that all changes or modifications derived from the definitions and scopes of the claims and their equivalents fall within the scope of the present invention.

What is claimed is:

1. A method of selectively recovering lithium from a waste cathode active material, the method comprising:
a step of mixing and calcining a waste cathode active material and a carbon source;
a step of leaching a valuable metal in the calcined mixture under acidic conditions; and
a step of recovering the leached valuable metal,
wherein, in the step of mixing and calcining the waste cathode active material and the carbon source, lithium contained in the waste cathode active material is converted into lithium carbonate so that lithium is selectively leached through the step of recovering the leached valuable metal, and
in the step of mixing and calcining the waste cathode active material and the carbon source, the average particle size of the carbon source is 220 μm or less.

2. The method of selectively recovering lithium from a waste cathode active material according to claim 1, wherein the step of calcining is performed at a temperature between 600° C. and 800° C.

3. The method of selectively recovering lithium from a waste cathode active material according to claim 1, wherein the step of leaching a valuable metal in the calcined mixture under acidic conditions is performed at a temperature of 15° C. to 45° C.

4. The method of selectively recovering lithium from a waste cathode active material according to claim 1, wherein the step of leaching a valuable metal in the calcined mixture under acidic conditions is performed at a high liquid-to-solid ratio of 5 to 10.

5. The method of selectively recovering lithium from a waste cathode active material according to claim 1, wherein the step of leaching a valuable metal in the calcined mixture under acidic conditions is performed at pH 4 to 7.

6. The method of selectively recovering lithium from a waste cathode active material according to claim 1, further comprising:
a step of adding a neutralizing agent to a lithium leachate to precipitate and remove impurities other than lithium, after the step of leaching a valuable metal in the calcined mixture.

7. The method of selectively recovering lithium from a waste cathode active material according to claim 6, wherein the impurities include a carbonate ((Co—Ni—Mn)CO₃) or a hydroxide ((Co—Ni—Mn)(OH)₂).

8. The method of selectively recovering lithium from a waste cathode active material according to claim 6, wherein the neutralizing agent is one or more selected from the group consisting of NaOH, NH₄OH, Na₂CO₃, K₂CO₃, CaO, CaCO₃, MgCO₃, and MgO.

9. The method of selectively recovering lithium from a waste cathode active material according to claim 1, wherein the step of recovering the leached valuable metal includes a lithium recovery step of heating and concentrating a lithium leachate and then carbonating the same to recover as lithium carbonate.

10. The method of selectively recovering lithium from a waste cathode active material according to claim 9, wherein, in the lithium recovery step of heating and concentrating a lithium leachate and then carbonating the same to recover as lithium carbonate, the carbonating is performed by selecting one or more carbonates from the group consisting of Na₂CO₃, K₂CO₃, CaCO₃, and MgCO₃ and adding the same in an amount of 20 to 120 equivalents relative to the calcium concentration of a lithium leachate.

11. The method of selectively recovering lithium from a waste cathode active material according to claim 9, wherein the lithium recovery step of heating and concentrating a lithium leachate and then carbonating the same to recover as lithium carbonate is performed at a temperature between 60° C. and 95° C.

12. The method of selectively recovering lithium from a waste cathode active material according to claim 9, wherein the lithium recovery step of heating and concentrating a lithium leachate and then carbonating the same to recover as lithium carbonate is performed for 0.1 to 2 hours.

13. The method of selectively recovering lithium from a waste cathode active material according to claim 9, wherein, in the lithium recovery step of heating and concentrating a lithium leachate and then carbonating the same to recover as lithium carbonate, after the carbonate is added, a base is added to adjust the pH to 11 to 12.

14. The method of selectively recovering lithium from a waste cathode active material according to claim 9, further comprising:
a step of performing washing for 0.1 to 2 hours under the conditions of a liquid-to-solid ratio of 7 to 15:1,
after the lithium recovery step of heating and concentrating a lithium leachate and then carbonating the same to recover as lithium carbonate.

15. The method of selectively recovering lithium from a waste cathode active material according to claim 1, further comprising:
a step of recovering valuable metals of cobalt (Co), nickel (Ni), and manganese (Mn) from a residue separated from a lithium leachate leached by the step of leaching a valuable metal in the calcined mixture under acidic conditions.
